(19) United States
(12) Patent Application Publication
(10) Pub. No.: US 2009/0154649 A1
(43) Pub. Date: Jun. 18, 2009

(54) X-RAY TUBE WHOSE ELECTRON BEAM IS MANIPULATED SYNCHRONOUSLY WITH THE ROTATIONAL ANODE MOVEMENT

(75) Inventor: Rolf Karl Otto Behling, Norderstedt (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/301,636

(22) PCT Filed: May 14, 2007
(86) PCT No.: PCT/IB2007/051814

§ 371 Date: Nov. 20, 2008

(30) Foreign Application Priority Data
May 22, 2006 (EP) 06114295.6

(51) Int. Cl. H01J 35/30

(52) U.S. Cl. 378/137

(57) ABSTRACT

It is described an X-ray tube (100) comprising a rotating anode (130), which is provided with a pull electrode (140). The pull electrode (140) interacts with a fixed electron source (110) in order to generate a modulated electron beam (120a, 120b). The beam modulation may be an intensity variation and/or a spatial deflection. The pull electrode (140) is mounted in a fixed position with respect to the anode (130) and rotates together therewith. The pull electrode (140) may have a hole (141) for passing the electron beam (120a). When being in front of the electron source (110), the pull electrode (140) causes a high electric field (142a) such that a strong electron beam (120a) is generated. When being not in front of the electron source (110) only a low current or a zero current electron beam (120b) is generated. However, the pull electrode (740) may also cause a radial beam deflection such that depending on the angular position of the anode (730) the position of a focal spot (721a, 721b) of the electron beam (720) is varied.

### FIELD OF INVENTION

The present invention relates to the field of generating X-rays by means of X-ray tubes. In particular, the present invention relates to an X-ray tube wherein an electron beam impinging onto an anode of the X-ray tube is periodically manipulated. Thereby, the manipulation may comprise a variation of the beam current such that the generated X-ray intensity may be modulated in time. The manipulation may also comprise a spatial variation such that a focal spot of the electron beam impinging onto the anode may be varied spatially.

The present invention further relates to an X-ray system, in particular a medical X-ray imaging system, wherein the X-ray system comprises an X-ray tube as mentioned above.

Further, the present invention relates to a method for generating X-rays, which are in particular used for medical X-ray imaging, wherein there is used an X-ray tube as mentioned above.

### ART BACKGROUND

Computed tomography (CT) is a standard imaging technique for radiology diagnosis. In some circumstances, it is desirable to provide a CT system with a pulsed X-ray source, wherein the intensity of the emitted X-rays is modulated in time. For instance an X-ray imaging of fast-moving organs of the human body, e.g. the heart region, requires an X-ray source, which provides for a timed switching of the electron beam. However, pulsed X-ray sources may also be used for other applications such as two-dimensional fluoroscopy of moving objects or therapeutic radiology.

In order to control the X-ray output dose of an X-ray tube it is necessary to control the current of an electron beam impinging onto an anode of the X-ray tube. There are known different measures for modulating the electron beam current within an X-ray tube.

A first known measure is to vary the temperature of an electron emitter such as a hot cathode. Thereby, it is possible to control the number of electrons, which are released from the electron emitter within a certain time interval.

A second known measure is to power the X-ray tube with a pulsed high voltage source such that the electric field in between an electron source and the anode of the X-ray tube is varied in time. Thereby, an electrostatic force acting on electrons, which have been released from an electron emitter, is varied in time such that electrons being present in an electron cloud surrounding the electron emitter are removed from the cloud in a pulsed manner.

A third known measure is to vary the electric field directly in front of the electron emitter. This may be realized by applying a pulsed voltage to an electrode, which is located in close proximity to the electron emitter. The electrode may be for instance a grid, which allows the electron beam to penetrate through the electrode.

All these measures have the disadvantage that the generation of a pulsed electron beam is based on applying relatively high alternating voltages or currents to various components of the X-ray tube. However, all these components and also corresponding supply lines for these components have parasitic capacitances and impedances such that the corresponding voltage or current signals are smeared out. Therefore, a stepwise switching of the X-ray intensity is only possible if costly voltage or current sources are employed for modulating the electron beam.

Moreover, there are also X-ray imaging applications, where it is desirable to provide a CT system with an X-ray source, which is capable of rapidly shifting a focal spot emitting X-rays from one place to another with respect to the patient being examined. It has been proposed to effect such shifting by electric and/or magnetic deflection of an electron beam impinging onto a surface of an anode of an X-ray tube.

It has also been proposed to provide for a spatial focal spot shift by moving the surface of an anode. Thereby, the electron beam may hit the anode surface at different distances with respect to the corresponding electron source.

U.S. Pat. No. 4,107,563 discloses an X-ray generating tube, which is especially suitable for being used in a CT apparatus. The X-ray generating tube comprises a rotating anode, which can be shifted linearly along a rotational axis of the anode in an oscillatory manner. The anode oscillation is realized by means of a so-called figure-of-eight groove, which is formed at a shaft of the rotating anode and which mechanically interacts with pegs being provided at a bearing of the rotating shaft. When the anode is shifted with respect to an envelope of the X-ray tube, a focal spot representing the origin of the generated X-rays is also moved with respect to the envelope.

JP 58-117629 discloses a small-sized and low cost X-ray tube for generating an X-ray microbeam by deforming and processing the shape of a target of the X-ray tube so that the traveling distance of the electron beam may change in response to the rotation of the target.

U.S. Pat. No. 5,907,592 discloses a CT apparatus for producing sets of projection measurements of an object under examination. The CT apparatus comprises an X-ray source having an anode surface, which is shaped in such a manner that during a rotation of the anode the generated X-ray beam is sequentially modulated between two focal spot locations. Thereby, during each rotation of the anode two sets of projection data are acquired wherein these projection data represent two different slices of the object. The projection data are used in an interlaced manner for reconstructing the image of the object.

There may be a need for providing an X-ray tube, which allows for an easy and a fast manipulation of an electron beam such that the generated X-rays are modulated in time.

### SUMMARY OF THE INVENTION

This need may be met by the subject matter according to the independent claims. Advantageous embodiments of the present invention are described by the dependent claims.

According to a first aspect of the invention there is provided an X-ray tube comprising (a) an electron source, adapted for generating an electron beam projecting along a beam axis, (b) an anode, which is arranged within the beam axis such that the electron beam impinges onto a focal spot of a surface of the anode, the anode being rotatable around a z-axis, and (c) an electron beam manipulation device, which is attached to the rotatable anode.

This aspect of the invention is based on the idea that the rotation of the anode may be employed in an advantageous manner for manipulating the electron beam in a synchronized manner with respect to the anode movement. Thereby, parts rotating with the anode are adapted to modulate the electron beam impinging onto the anode surface. Of course, the period of the beam manipulation is shorter than the period of an anode revolution. Typically, the anode rotates with a rotational speed of approximately between 10 Hz and 1 kHz. Preferably, the anode rotates with a rotational speed of approximately between 50 Hz and 200 Hz.

The described X-ray tube may be realized by performing rather simple modifications to a know X-ray tube. The only modification being necessary is to provide a holding arrangement for the electron beam manipulation device such that it is rigidly fixed to the rotatable anode.

Typically, the electron source is a hot cathode. This has the advantage that the electron current may be adjusted precisely by adequately controlling the temperature of the hot cathode material.

According to an embodiment of the invention the electron beam manipulation device is an electromagnetic force generation device, which is adapted to exert an electromagnetic force on electrons of the electron beam. By contrast to known dynamically operated electromagnetic force generation devices, which are typically arranged at a spatially fixed position within the X-ray tube, the rotating electromagnetic force generation device may be operated with static charges and/or static currents comprising a more or less constant amperage. Therefore, the described X-ray tube has the advantage that it is not necessary to apply high alternating voltage levels or alternating currents to the rotatable electromagnetic force generation device. Therefore, parasitic capacitances and/or impedances do less or not at all contribute to a flattening of applied voltage and/or current signals such that in a very good approximation a stepwise modulation of the electron beam may be realized.

According to an embodiment of the invention the electromagnetic force generation device comprises an electrode for electrically manipulating the electron beam, wherein the electrode is connectable to a defined voltage level. This provides the advantage that a modulation of the electron beam intensity may be realized by controlling static voltage levels, which are applied to the electrode being rotatable in conjugation with the anode.

By contrast to a beam modulation based on magnetic interactions between the electrons and the electromagnetic force generation device, a precise control of the beam may be realized much more easily because no electric currents have to be generated for the electromagnetic force generation device. However, it has to be mentioned that a beam modulation based on magnetic interactions may also be realized with permanent magnets, which are spatially fixed to the rotatable anode.

In case an electromagnetic force generation device based on magnetic interaction is employed in order to modulate the intensity of the electron beam, it may be useful to use an electron beam dump as an electron trap in order to remove the electrons from the electron beam path.

It has to be pointed out that the electromagnetic force generation device may also comprise more than one electrode or more than one electrode part, which may be at different voltage levels with respect to each other. Thereby, a modulated electron beam may be provided, which comprises not only two but more than two different electron beam states.

According to a further embodiment of the invention the electrode is at the same voltage level as the anode. This has the advantage that no additional electrical connections between the moving electrode and a typically stationary voltage source have to be provided.

According to a further embodiment of the invention (a) the anode is a disk comprising a rotational symmetry with respect to the z-axis and (b) in a top view of the anode the electrode covers at least one sector of the anode. Preferably, the disk is flattened or tapered within an outer annulus region of the disk. This has the advantage that depending on the flattening angle the generated X-rays may be emitted mainly in a direction being essential perpendicular to the z-axis.

According to a further embodiment of the invention the X-ray tube further comprises an electron-focusing device, which is arranged in between the electron source and the electromagnetic force generation device, when the angular position of the anode is within a predefined angular range. This may provide the advantage that the length and the width of the focal spot may be accurately controlled such that the X-rays being generated from the X-ray tube originate from a spatially precisely defined region of the anode surface.

The electron-focusing device may be for instance a wehnelt cylinder. This is a cylindrically shaped electrode that, containing the cathode of the X-ray tube with opposite potential, is designed to focus and spatially control the electron beam.

According to a further embodiment of the invention the electrode comprises an opening. This has the advantage that a predominately homogenous electric field may be generated in between the electron source and the electrode, when the electrode is located directly next to the electron source. In case the electrode is at a voltage level being more positive than the electron source, an electric pull field may be generated, or an existing pull field may be enhanced, which causes electrons surrounding the cathode of the electron source to be pulled out from this cloud (space charge) such that due to the thereby limited space charge the intensity of the electron beam may be increased significantly. Thereby, the electric pull field has to be stronger than the electric acceleration field being generated in between the electron source and the anode. Of course, the strength of the electric pull field does not only depend on the voltage difference between the electron source and the electrode, the strength of the electric pull field does also depend on the distance between the electron source and the electrode.

The provision of an opening within the electrode has the further advantage that a high penetration factor of the electron beam may be achieved. This is in particular the case when the opening comprises such a size that the electron beam may traverse the electrode without abutting against edges or corners of the electrode or parts of the electrode.

Preferably, the electromagnetic force generation device is adapted to manipulate the beam intensity in such a manner that depending on the angular position of the anode with respect to the electron source, the electron beam may impinge onto the anode surface with a maximum intensity or the electron beam may be completely switched off such that no X-rays are generated. Thereby, a pulsed X-ray source is provided.

According to a further embodiment of the invention the electrode comprises at least two parts, which are mechanically connected with each other by means of a holder. Preferably, the holder may also be used for electrically connecting the two parts with each other.

According to a further embodiment of the invention the holder comprises a bar or a rod. These elements are characterized by having a pronounced elongated shape. This may provide the advantage that the holder generates only very small shadowing effects for the electron beam such that the propagation of the electron beam is hardly disturbed.

Preferably, the holder comprises an arrangement of bars or rods such that a mechanical stable frame made from these elements may be realized. Thereby, the frame may mechanically connect the two electrode parts by means of two spatially separated connections such that a stable and warp resistant mechanical connection between the two electrode parts may be provided.

According to a further embodiment of the invention the holder is arranged within a region wherein due to the presence of the electrode the electrical field between the electron source and the anode is reduced. This has the advantage that only a very small distortion of the electron acceleration field in between the electron source and the anode is generated and only a small number of electrons or none at all may hit the holder.

According to a further embodiment of the invention the electromagnetic force generation device protrudes from the anode in such a manner that, when the electromagnetic force generation device is found in between the electron source and the anode, only a small gap remains in between the electron source and the electrode. This has the advantage that a very strong electric field may be provided between the electron source and the electrode. Therefore, electrons being released from the electron source may be pulled effectively into the electron beam. However, it has to be taken into account that the gap must be wide enough in order to guarantee that the electrode does not mechanically crash with the electron source even when the described X-ray tube is handled not smoothly. Further, it has to be taken into account that no vacuum discharges occur between different component parts, which are on different potential.

Preferably, the small gap has a width, which is smaller than approximately 10% of the distance between the electron source and the anode. More preferably, the small gap has a width, which is smaller than approximately 5% of the length of the whole electron beam path extending between the electron source and the anode surface. The provision of only a small gap has the advantage that a very high electric pull field is generated, which is adapted to effectively pull out electrons from a electron cloud surrounding the electron source.

According to a further embodiment of the invention the electromagnetic force generation device comprises at least two electrodes. Preferably, the electrodes are distributed in a symmetric manner along the circumference of the anode such that X-ray pulses may be generated having a constant repetition rate.

According to a further embodiment of the invention the X-ray tube further comprises an electron-repelling device, which is adapted to suppress the electron beam current at least partially when the electrode is in an angular position aside from the electron source. This may provide the advantage that the modulation index i.e. the ratio between the electron beam intensity being enhanced due to the presence of the pull electrode and the electron beam intensity being reduced due to the presence of the electron-repelling device may be increased significantly. A high modulation index has the advantage that a switched respectively a pulsed X-ray source may be provided with a rather simple modification of a known X-ray tube. Of course, the time behavior of the X-ray pulses still depends on the anode revolution.

According to a further embodiment of the invention the electron-repelling device is arranged in a spatially fixed position with respect to the electron source. This has the advantage that the electron-repelling device may be realized without using any movable parts such that the provision of the electron-repelling device does not make the assembling of the X-ray tube more complicated, that the electron-repelling potential may be comparatively small and the insulation means may be realized in a simple but effective way. The fixed electron-repelling device may preferably be attached to the electron source.

Of course, the fixed electron-repelling device provides for a repelling force exerted to the electrons of the electron beam wherein the repelling force is independent of the actual angular position of the anode. However, the electromagnetic interaction between the pull electrode and the electrons being released from the electron source may be much stronger than the interaction between the electron-repelling device and the released electrons. In other words, the presence of the pull electrode overcompensates the effect of electron-repelling device.

However, it has to be mentioned that it is of course also possible to apply an alternating voltage to an electrically operated electron-repelling device, wherein the alternating voltage is synchronized with the anode movement.

According to a further embodiment of the invention the electron-repelling device is a grid, which is chargeable with a negative voltage with respect to the electron source. This has the advantage that the electron-repelling device and, as a consequence, the whole X-ray tube may be realized with component parts which are well known in the field of designing and manufacturing X-ray tubes.

According to a further embodiment of the invention the electron-repelling device is attached to the anode. Preferably, the electron-repelling device is located in a sector of the anode, which sector is arranged beside or beneath the anode sector, which is assigned to the electrode.

In order to provide for a maximum modulation index the anode surface may be segmented into at least one first sector being assigned to the electrode and into at least one second sector being assigned to the electron-repelling device. This has the advantage that the electron beam is subjected either to an electron-pulling device promoting the electron beam or to the electron-repelling device hindering the propagation of the electron beam.

According to a further embodiment of the invention the electron-repelling device comprises an electrically isolating material. This has the advantage that the isolating material provides for a self-suppression of the electron beam because, when electrons impinge on the isolating material, it will automatically be charged up such that further electrons are rejected because of the electric field generated by the charged electron-repelling device. This means that the electron-repelling device represents a so-called electron mirror leading to an effective suppression of the electron beam.

According to a further embodiment of the invention the electromagnetic force generation device is an electron deflection device for spatially manipulating the electron beam. The manipulation of the electron beam has the effect that during operation of the described X-ray tube the position of the focal spot on the anode surface spatially varies in a synchronized manner with the anode rotation. Such a variation may be used for instance for dual focus X-ray systems wherein an object under examination is penetrated with two slightly different sets of X-ray originating from spatially different focal spots.

According to a further embodiment of the invention the electron deflection device is adapted to radially deflect the electron beam with respect to the z-axis. This has the advantage that the electron beam is moved perpendicular to the circular motion of the anode surface portions such that a precise control of the focal spot position may be achieved.

According to a further embodiment of the invention the X-ray tube further comprises a further electrode, wherein the further electrode is connectable to a further voltage level. In particular when the defined voltage level and the further voltage level have a different algebraic sign one electrode may act as a pull electrode whereas the other electrode may represent a push electrode. Thereby, the electron beam deflection may be enhanced such that the focal spot may be varied within a comparatively wide region on the anode surface.

According to a further embodiment of the invention the further electrode is arranged in a spatially fixed position with respect to the electron source. This has the advantage that the further electrode may be contacted very easily since no electrical connections between a voltage source and a moving member have to be provided.

According to a further embodiment of the invention the further electrode is at the same voltage level as the electron source. This has the advantage that no extra voltage source has to be provided for powering the further electrode. When the first electrode is at the same voltage as the anode, compared to the voltage levels being provided anyway for operating the X-ray tube, no additional voltage levels have to be provided in order to realize the described X-ray tube. Therefore, starting from known X-ray tubes the described X-ray tube may be realized with a comparatively simple mechanical setup only.

According to a further embodiment of the invention the electron deflection device protrudes from the anode in such a manner that the electron beam may be manipulated basically along the whole electron path length between the electron source and the anode. In other words, there is only a very narrow gap in between the electron source and the electron deflection device. Therefore, the electrons being emitted from the electron source may interact with the electron deflection device within an interaction length, which is as long as possible. However, it has to be taken into account that the gap must be wide enough in order to guarantee that the electron deflection device does not mechanically crash with the electron source and/or with the electron focusing device even when the described X-ray tube is handled not smoothly. Further, it has to be ensured that no vacuum discharges occur.

Preferably, the interaction length is at least 90% of the length of the whole electron beam path between the electron source and the anode. More preferably, the interaction length is at least 95% of the length of the whole electron beam path.

According to a further embodiment of the invention the electron deflection device is adapted to discretely deflect the electron beam such that (a) a first focal spot is generated when the angular position of the anode is within a first angular range and (b) a second focal spot is generated when the angular position of the anode is within a second angular range. This has the advantage that a dual focus X-ray tube may be realized by means of a simple mechanical setup.

It has to be mentioned that the electron deflection device may also be adapted such that during one revolution of the anode three or even more different focal spots are sequentially generated. In this case the electron deflection device has to comprise three or even more segments whereby each segment is assigned to a certain angular range of the rotatable anode.

Further, it has to be mentioned that the electron deflection device may also be formed in such a manner that during one revolution of the rotatable anode the focal spot is switched two times or even more often back and forth between two or even more spatially different focal spots. This means that compared to the periodicity of the anode movement the focal spot is varied with a higher harmonic periodicity.

According to a further aspect of the invention there is provided an X-ray system, in particular a medical X-ray imaging system like a computed tomography system. The provided X-ray system comprises an X-ray tube according to any one of the above-described embodiments of the X-ray tube.

This aspect of the invention is based on the idea that the above-described X-ray tube may be used for various X-ray systems in particular for medical diagnosis.

One may take benefit from a pulsed illumination of an object under examination e.g. for allowing to acquire sharp X-ray images of a moving object.

Further, one may take benefit from illuminating an object under examination with two different sets of X-rays, whereby the two X-ray sets penetrate the object under different illumination angles. When using a detector array for sensing the X-rays having traversed the object, one can design the X-ray system such that the so-called interleaving technique is applied. Thereby, neighboring X-rays originating from different focal spots are separated from each other by a distance being half of the distance between neighboring X-rays in the case when only one focal spot is used. This has the advantage that when the two X-ray acquisitions assigned to the two focal spots are combined in an appropriate manner, the spatial resolution of the X-ray system may be enhanced. Under optimal conditions the spatial resolution may be doubled.

Further, one may take benefit from illuminating an object under examination with two different X-ray tubes, whereby the two X-ray beams, generated, penetrate the object under much different illumination angles, e.g. under 90 degree offset in the rotor of a CT system. Thereby, the current modulation capability is being used to switch back and forth between both X-ray tubes.

It has to be mentioned that the described X-ray system may also be used for other purposes than medical imaging. For instance the described X-ray system may also be employed e.g. for security systems such as baggage inspection apparatuses. Thereby, a pulsed X-ray source allows for an inspection of baggage items, which are provided on a comparatively fast moving conveyor belt.

According to a further aspect of the invention there is provided a method for generating X-rays, in particular for generating X-rays being used for medical X-ray imaging like computed tomography. The provided method comprises using an X-ray tube according to any one of the above-described embodiments of the X-ray tube.

It has to be noted that embodiments of the invention have been described with reference to different subject matters. In particular, some embodiments have been described with reference to apparatus type claims whereas other embodiments have been described with reference to method type claims. However, a person skilled in the art will gather from the above and the following description that, unless other notified, in addition to any combination of features belonging to one type of subject matter also any combination between features relating to different subject matters, in particular between features of the apparatus type claims and features of the method type claims is considered to be disclosed with this application.

The aspects defined above and further aspects of the present invention are apparent from the examples of embodiment to be described hereinafter and are explained with reference to the examples of embodiment. The invention will be described in more detail hereinafter with reference to examples of embodiment but to which the invention is not limited.

### BRIEF DESCRIPTION OF THE DRAWINGS

FIG. 1a shows a cross sectional view of an X-ray tube according to a preferred embodiment of the invention, wherein the rotatable anode is in a first angular position.

FIG. 1b shows a cross sectional view of the X-ray tube shown in FIG. 1a, wherein the rotatable anode is in a first angular position.

FIG. 2a shows a top view of the anode of the X-ray tube shown in FIGS. 1a and 1b.

FIG. 3a shows a top view of the anode shown in FIGS. 1a and 1b, wherein different focal spot tracks are indicated, which are assigned to different beam currents.

FIG. 3b shows a diagram illustrating the beam current as a function of the rotation phase of the anode.

FIG. 4a shows a top view of an anode comprising four pull electrodes, which are distributed equally along the anode circumference.

FIG. 4b shows a diagram illustrating the beam current as a function of the rotation phase of the anode shown in FIG. 3a.

FIG. 5 shows a top view of an anode comprising four pull electrodes and four electrostatic electron mirrors.

FIG. 6 shows a cross sectional view of an X-ray tube comprising a chargeable grid attached to an electron source of the X-ray tube, wherein the chargeable grid act as a stationary electron-repelling device.

FIG. 7a shows a cross sectional view of an X-ray tube according to a further embodiment of the invention, wherein the rotatable anode is in a first angular position.

FIG. 7b shows a cross sectional view of the X-ray tube shown in FIG. 7a, wherein the rotatable anode is in a second angular position.

FIG. 8a shows a top view of the anode of the X-ray tube shown in FIG. 7a.

FIG. 8b shows a diagram illustrating the beam deflection as a function of the rotation phase of the anode shown in FIG. 8a with respect to the focal spot.

### DETAILED DESCRIPTION

The illustration in the drawing is schematically. It is noted that in different figures, similar or identical elements are provided with the same reference signs or with reference signs, which are different from the corresponding reference signs only within the first digit.

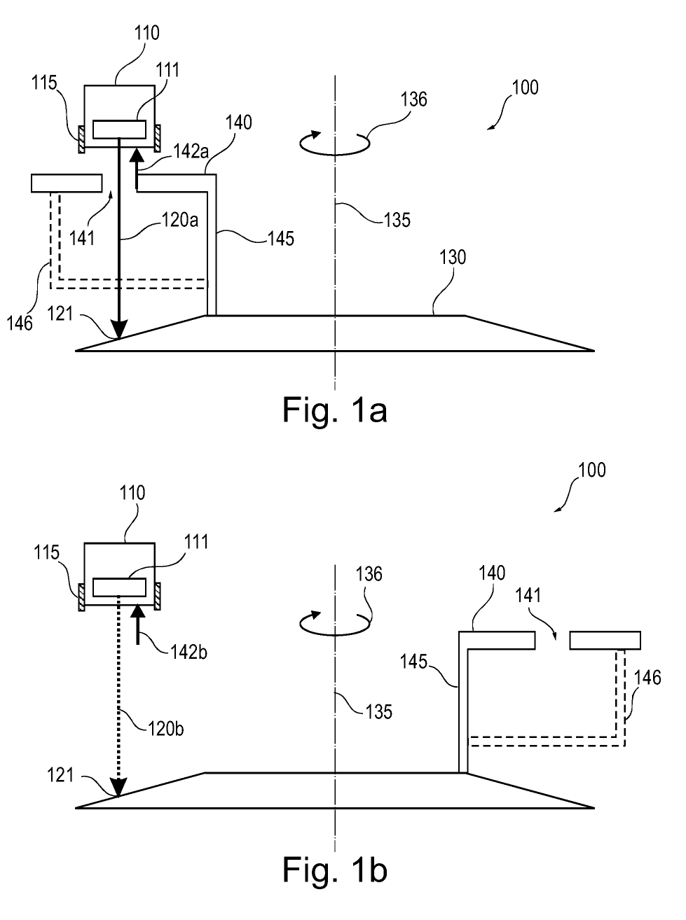

In the following the structure of an X-ray tube 100 representing a preferred embodiment of the invention is explained with reference to FIG. 1a and FIG. 1b. Thereby, FIG. 1a shows a cross sectional view of the X-ray tube 100 at a first point in time whereas FIG. 1b shows a cross sectional view of the X-ray tube 100 at a second point in time.

The X-ray tube 100 comprises an electron source 110. The electron source 110 includes a hot cathode 111 and an electron-focusing device 115, which is realized by means of a so-called wehnelt cylinder. When operated properly, the electron source 110 emits an electron beam 120a.

The X-ray tube 100 further comprises a rotatable anode 130, which has a rotational symmetric shape. The anode 130 has the shape of a disk, which is flattened within its an outer annulus shaped region. The anode 130 is supported in a pivot bearing (not depicted). Further, the anode 130 is coupled to a rotational drive (not shown), which in operation rotates the anode 130 around a rotational axis 135. The direction of the rotational movement is indicated with the arrow 136.

The electron beam 120a impinges onto a focal spot 121 of the upper surface of the anode 130.

In order to control the intensity of the electron beam 120a, the anode 130 is provided with an electromagnetic force generation device, which according to the embodiment described here is a pull electrode 140. The pull electrode 140 is mounted to the rotatable anode 130 by means of a holder 145, which projects upwards from the upper surface of the anode 130.

The holder 145 is not only used for mechanically supporting the pull electrode 140. The holder 145 serves also as an electrical connector between the electrode 140 and the anode 130. This means that the pull electrode 140 is always at the same voltage level as the anode 130. Typically, the electron source 110 is at ground level whereas the anode 130 and the pull electrode 140 are at a voltage level of approximately +40 kV to +225 kV. Thereby, X-ray photons within the relevant energy range may be generated.

The pull electrode 140 is shaped in such a manner that above a first sector of the anode 130 the electrode 140 extends around the rotational axis 135 in a rotational symmetric manner. In other words, the electrode 140 has the shape of an annulus, which however is limited to the first sector of the anode 130.

Within the electrode 140 there is formed an opening 141. The opening 141 is shaped in such a manner that the electron beam 120a may penetrate the pull electrode 140. According to the embodiment described here the opening is a slit 141, which has the shape of a limited circular arc. Therefore, the electrode 140 is effectively made from two parts, which are mechanically and electrically connected by means of a frame 146 made from spokes. In the rotational phases depicted in FIGS. 1a and 1b respectively, the spokes 146 lie above and below the shown cross sectional plane. This situation is illustrated by the dashed lines, which indicate the spokes 146.

When the pull electrode 140 is found beneath the electron source 110 (see FIG. 1a), an electric pull field 142a is generated, which is much bigger than the electric field between the electron source 110 and the anode 130 in the absence of the electrode 140. The increase of the electric field directly beneath the electron source 110 is based on the fact that the distance between the electron source 110 and the pull electrode 140 is much smaller than the distance between the electron source 110 and the upper surface of the anode 130. The increased pull field 142a has the effect that an increased number of electrons are extracted from an electron cloud surrounding the hot cathode 111. In other words, the electron beam current not only depends on the temperature of the hot cathode 111, the electron beam current also strongly depends on the magnitude of the electric pull field 142a. Therefore, the presence of the pull electrode 140 being at the same voltage level as the anode 130 and located directly beneath the electron source 110 significantly increases the current of the electron beam 120a. This situation is depicted in FIG. 1a.

When the pull electrode 140 is found aside of the electron source 110 (see FIG. 1b), a electric pull field 142b is present at the hot cathode 111. The electric pull field 142b corresponds to the electric field generated by the voltage difference between the electron source 110 and the anode 140. Of course this electric field strongly depends on the distance between the electron source 110 and the anode 140. By contrast to the strong electric pull field 142a indicated in FIG. 1a, the weak field 142b removes much less electrons from the electron cloud surrounding the cathode 111. This has the effect, that the electron beam 120b comprises a much less current respectively amperage. This situation is illustrated by the dotted arrow 120b.

It has to be mentioned that the geometry of the X-ray tube 100 and the voltage levels of the electron source 110 and the anode 130 respectively the pull electrode 140 may be adjusted in such a manner that a beam switching may be achieved. Thereby, the electron beam 120a comprises a predefined amperage whereas the electron beam 120b is completely switched off i.e. no electrons reach the anode surface.

Further, it is pointed out that due to the fact that the pull electrode 140 is located directly beneath the electron source 110 respectively the electron focusing device 115, the electrons of the electron beam 120a are accelerated predominately within the electric field extending in between the electron source 110 and the pull electrode 140. In other words, the space between the pull electrode 140 and the upper surface of the anode 130 comprises only a very weak electrical field. This means that in order not to allow for a strong defocusing of the electron beam 120a within this space the electron-focusing device 115 has to be adjusted properly.

Preferably, the spokes 146, which connect the inner and the outer part of the pull electrode 140, are positioned in a region comprising a low electric field only. This has the advantage that the an electric field distortion due to the presence of the spokes may be minimized such that a defocusing of the electron beam 120a may be neglected in a good approximation.

It should be clear that when the anode 130 rotates around the rotational axis 135 the intensity of the electron beam 120 switches between two different values. When the pull electrode 140 is found beneath the electron source 110, the electron beam 120a is generated having a high beam current (see FIG. 1a). When the pull electrode 140 is not found beneath the electron source 110, the electron beam 120b is generated having a low beam current (see FIG. 1b). Thereby, the intensity of the electron beams 120a, 120b is automatically modulated in a synchronized manner with respect to the anode movement. Of course, the pulse width is always shorter than the period on the anode revolution.

At this point it has to be mentioned that of course the presence of the pull electrode 140 has an influence on the lines of electrical flux between the electron source 110 and the anode 130. In order to avoid a defocusing of the electron beam 120a and as a consequence to avoid an enlarged focal spot 121, the electron-focusing device 115 may be operated dynamically in synchronization with the anode movement such that both electron beams 120a and 120b impinge on the anode surface with approximately the same degree of focusing.

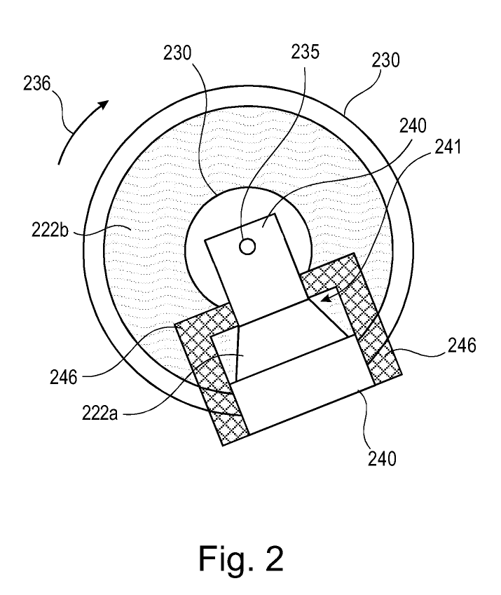

FIG. 2 shows a top view of the anode 130, which is now denoted with reference numeral 230. The anode 230 rotates clockwise around the rotational axis 235 as indicated by the arrow 236. The anode 230 is provided with a two-part pull electrode 240. The two parts of the pull electrode 240 are separated from each other via an opening 241 representing a gap. The opening 241 is formed and located in such a manner that an electron beam may penetrate the electrode 240 without being spatially disturbed.

The two parts of the electrode 240 are electrically and mechanically connected by means of a frame 246, which is assembled from various spokes. Further, the electrode 240 is electrically connected to the anode 230.

When the anode 230 and the electrode 240 commonly rotate around the rotational axis 235, the presence of the charged electrode 240 in between the electron source (not depicted in FIG. 2) and the anode 230 has a strong influence of the electrical pull field such that the electron beam intensity is being modulated in time. Thereby, an annulus of the anode 230 may be segmented into a first focal spot track 222a and a second focal spot track 222b. The first focal spot track 222a represents a region in which the high intensity electron beam 120a impinges onto the anode 230. The second focal spot track 222b represents a region in which the low or the zero intensity electron beam 120b impinges onto the anode surface.

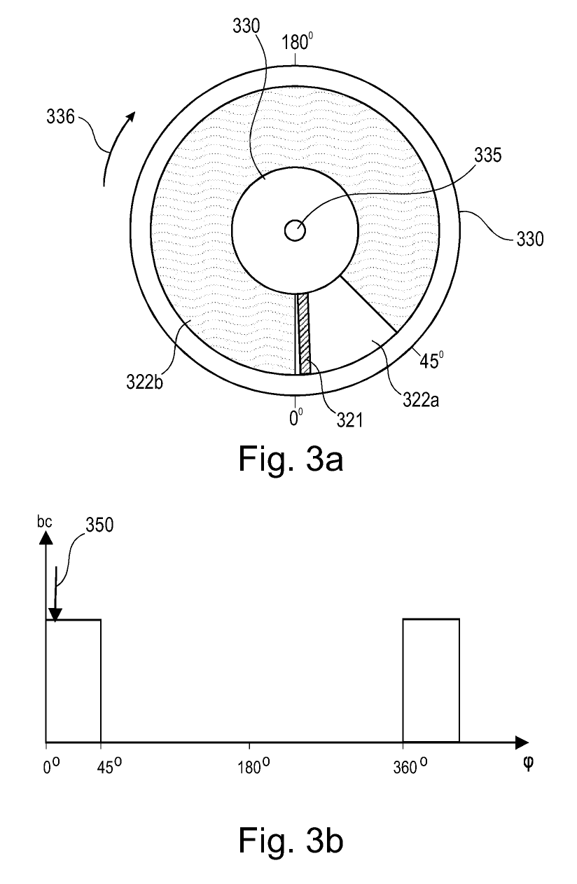

FIG. 3a shows a top view of the anode 230, which is now denoted with reference numeral 330. The anode 330 rotates around the rotational axis 335 as indicated by the arrow 336. The anode 330 is hit by an electron beam being emitted from a spatially fixed electron source (not depicted). Thereby, a spatially fixed focal spot 321 is generated. The focal spot 321 has the shape of an elongated rectangle. Since the X-rays generated within the focal spot 321 are emitted in a radial direction outwards from the rotational axis 335, the projection of the focal spot 321 perpendicular to the direction of the emitted X-rays is much smaller. Preferably, in this projection the focal spot 321 has the shape of a square.

As has already been explained above, the rotating electrode 240 modulates the electron beam intensity such that a first focal spot track 322a may be identified wherein the high intensity electron beam 120a impinges onto the anode 330. Accordingly, a second focal spot track 322b may be identified wherein the low or the zero intensity electron beam 120b impinges onto the anode surface.

According to the embodiment described here, the pull electrode 240 covers about 12.5% of the angular circumference of the anode 330. Therefore, within one revolution of the anode 330 the high intensity beam pulse will last about ⅛ of the period of the anode revolution. Those parts of the anode, which can only be subject to only a small electric current, may be even omitted or made of a material, which is not as thermo-mechanically stable as the part, which is subject to high current, i.e., which is carrying the focal track 322a.

FIG. 3b shows a diagram illustrating the temporal behavior of the beam current bc as a function of the phase φ of the anode rotation. It is assumed that the beam modulation is 100% i.e. that the intensity of the beam current is switched between zero current and maximal current. The anode 330 typically rotates with a constant angular velocity such that the phase φ is directly proportional to the time t.

The beam current bc is depicted with a phasing of the anode movement relative to the focal spot position 219, which phasing corresponds to the arbitrary phase points 0° and 180° as indicated in FIG. 3a. Thereby, in between a phase interval ranging from 0° to 45°, the electron beam impinges onto the anode with a maximum intensity. In between the phase points 45° and 360° the electron beam is suppressed. The arrow 350 indicates the phasing of the anode movement, which phasing is depicted in FIG. 3a. Of course, due to the periodicity of the anode movement the modulation of the beam current bc is also periodic with a period of 360°.

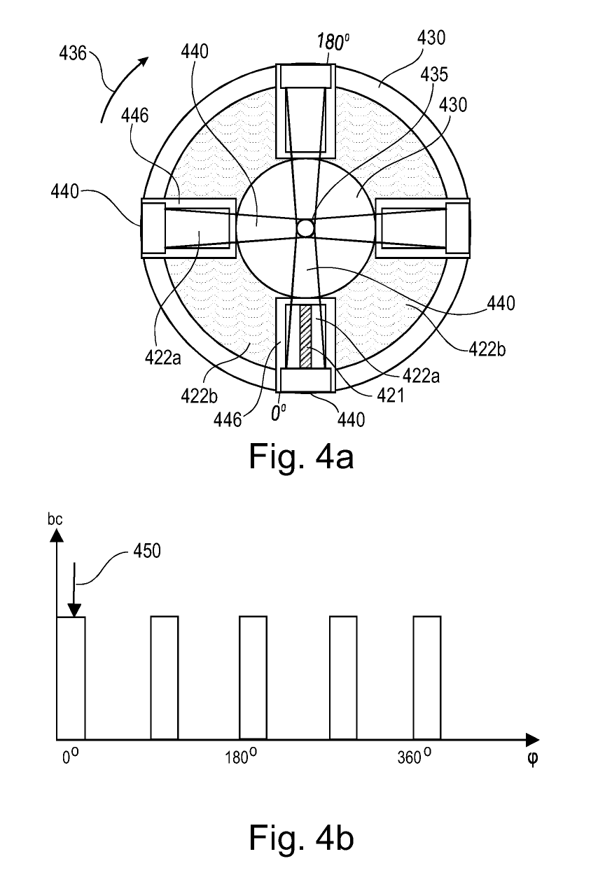

FIG. 4a shows a top view of an anode 430 being accommodated in an X-ray tube according to a further embodiment of the invention. The anode 430 is equipped with an electromagnetic force generation device comprising four pull electrodes 440 which are each electrically connected with the anode 430. The pull electrodes 440 are distributed equally along the anode circumference. Each electrode 440 comprises two parts, which are electrically and mechanically connected by means of a frame 446 made from spokes.

When the anode 430 rotates around the rotational axis 435 as indicated by the arrow 436, the spatially fixed focal spot 421 travels over the anode surface. Thereby, four focal spot tracks 422a may be identified, which each represent a region in which the high intensity electron beam 120a impinges onto the anode 430. Accordingly, four focal spot tracks 422b may be identified, which each represent a region in which the low or the zero intensity electron beam 120b impinges onto the anode surface.

FIG. 4b shows a diagram illustrating the temporal behavior of the beam current bc as a function of the rotation phase φ of the anode 430. It is again assumed that the beam modulation is 100% i.e. that the intensity of the beam current is switched between zero current and a maximal current. As can be expected from the electromagnetic force generation device comprising four equally distributed pull electrodes 440, within the phase interval between 0° and 360° four electron beam pulses are generated. Again, the arrow 450 indicates the phasing of the anode movement, which phasing is depicted in FIG. 4a.

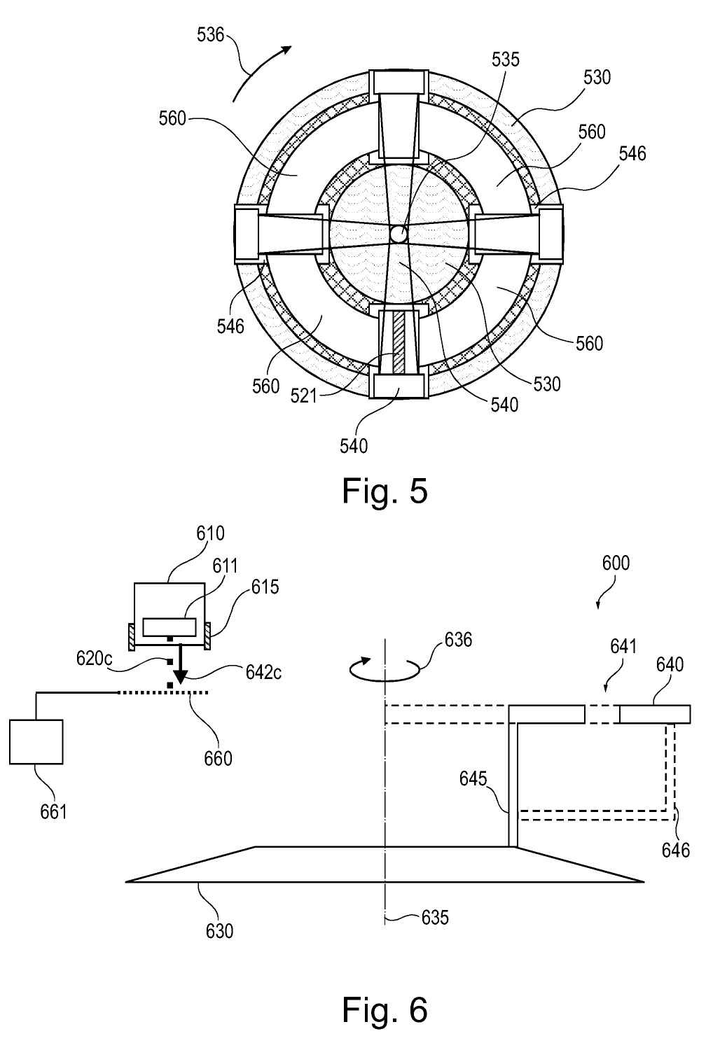

FIG. 5 shows a top view of a rotatable anode 530 being accommodated in an X-ray tube according to a further embodiment of the invention. Apart from the provision of four electron mirrors 560 the rotatable anode 530 is the same as the anode 430 depicted in FIG. 4. Therefore, the design of the anode 530 will not be described again in detail. Reference is made to the description of the anode 430 depicted in FIG. 4.

The electron mirrors 560 are located in between the four pull electrodes 540 and commonly rotate with the pull electrodes 540 around the rotational axis 535 when the anode is rotated as indicated by the arrow 536. The beam mirrors 560 comprise an electrically insulating material. When a beam mirror 560 is hit by the electron beam, the isolating material will be charged up negatively. This enhances the space charge in front of the electron source and cuts off the electron beam.

An X-ray tube being provided with electron mirrors 560 and with pull electrodes 540 allows for a much higher modulation of the electron beam intensity. This is based on the fact that when the pull electrodes 540 are found in front of the electron source the electrons will be electrostatically pulled out from the electron source and the beam intensity will be enhanced. When the electron mirrors 560 are found in front of the electron source the electrons will be electrostatically repelled from the anode such that the electron beam is suppressed.

FIG. 6 shows a cross sectional view of an X-ray tube 600 according to a further embodiment of the invention. The X-ray tube 600 predominately corresponds to the X-ray tube 100 depicted in FIGS. 1a and 1b. In order not to repeat the same description reference is made to the above given description of the X-ray tube 100.

By contrast to the X-ray tube 100 shown in FIGS. 1a and 1b, the X-ray tube 600 is additionally provided with a chargeable grid 660 being attached to the electron source 610 by means of a holder (not depicted). The chargeable grid 660 is electrically connected with a voltage source 661.

The fixed chargeable grid 660 provides for a repelling electric field 642c such that a repelling force acts on the electrons of the electron beam 620c. Therefore, in the absence of the pull electrode 640 beneath the electron source 610 the electron beam 620c is blocked.

Of course, the repelling function is independent from the actual angular position of the anode 630. However, when the pull electrode 640 is present beneath the electron source 610, the electromagnetic interaction between the pull electrode 640 and the electrons being released from the electron source 610 is much stronger than the interaction between the grid 660 and the released electrons. In other words, the presence of the pull electrode 640 overcompensates the effect of electron-repelling device. Of course, this overcompensation is only possible when the pull electrode 640 and the anode 630 are at a positive high voltage with respect to the electron source 610 and the grid 660 is at a negative low voltage with respect to the electron source 610, and the positions within the realized geometry are properly defined.

It has to be mentioned that it is of course also possible to apply an alternating voltage to the grid 660, wherein the alternating voltage is synchronized with the movement of the anode 630. Thereby, the grid 660 may be switched to a floating voltage level when the pull electrode is found beneath the electron source 610. This can also be used to modulate the focal spot size, as the modulated grid potential will in general influence the electric field lines and with it the focusing of the electron beam.

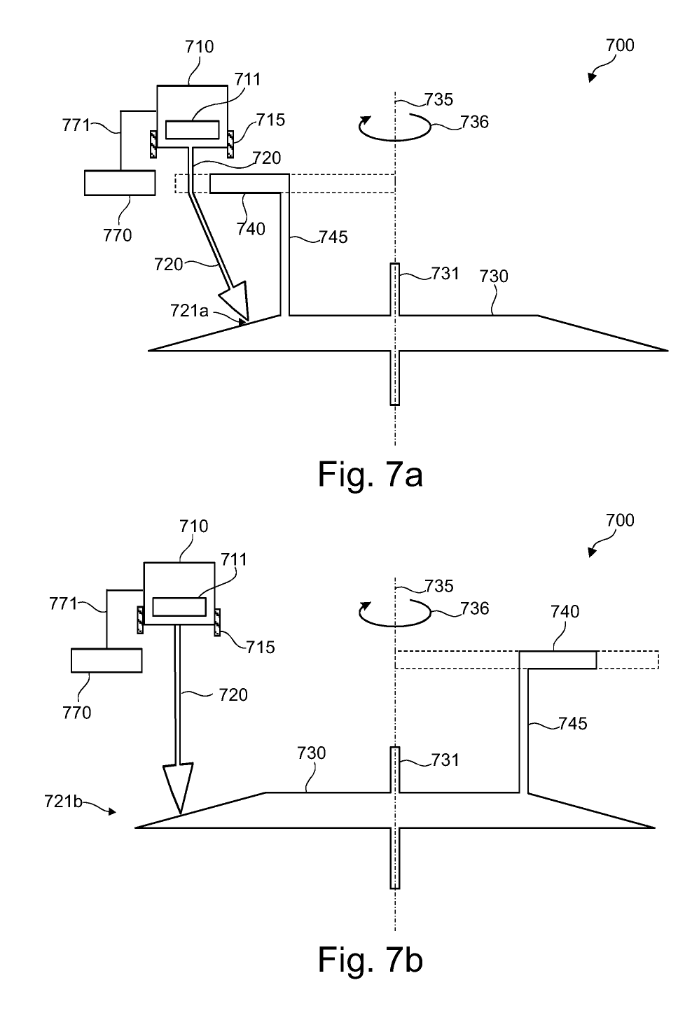

In the following the structure of an X-ray tube 700 representing a further embodiment of the invention is explained with reference to FIG. 7a and FIG. 7b. Thereby, FIG. 7a shows a cross sectional snapshot of the X-ray tube 700 at a first point in time whereas FIG. 7b shows a cross sectional snapshot of the X-ray tube 700 at a second point in time.

As can be seen from FIG. 7a and FIG. 7b, the X-ray tube 700 comprises an electron source 710. The electron source 710 includes a hot cathode 711 and an electron focusing device 715, which is realized by means of a so-called wehnelt cylinder. When operated properly, the electron source 710 emits an electron beam 720. Thereby, the current of the electron beam 720 strongly depends on the actual temperature of the hot cathode 711. The higher the temperature is the more electrons are released from the cathode material.

The X-ray tube 700 further comprises a rotatable anode 730, which has a rotational symmetric shape. As can be seen from FIGS. 7a and 7b, the anode 730 has the shape of a disk, which is flattened within its an outer annulus shaped region. The anode 730 is supported by means of a shaft 731, which is accommodated in a pivot bearing (not depicted). The shaft 731 is coupled to a rotational drive (not shown), which in operation rotates the anode 730 around a rotational axis 735. The direction of the rotational movement is indicated with the arrow 736.

The electron beam 720 impinges onto a focal spot 721a, 721b of the upper surface of the anode 730. As can be seen from FIGS. 7a and 7b, the positions of the focal spots 721a and 721b are separated from each other because the path of the electron beam 720 is not spatially constant.

In order to spatially control the electron beam 720 the anode 730 is provided with an electron deflection assembly. The electron deflection assembly comprises a holder 745 projecting from the upper surface of the anode 730. The electron deflection assembly further comprises a first electrode 740 being attached to the holder 745. Above a first sector of the anode 730 the first electrode 740 extends around the rotational axis 735 in a rotational symmetry. In other words, the first electrode 740 has the shape of an annulus, which however is limited to a predefined sector of the anode 730. As can be derived from the dashed lines indicating the electrode 740 in a side view, according to the embodiment described here, the predefined sector is a semi circle.

The holder 745 is not only used for mechanically supporting the first electrode 740. The holder 745 serves also as an electrical connector between the first electrode 740 and the anode 730. This means that the first electrode 740 is always at the same voltage level as the anode 730. Typically, the electron source 710 is at ground level whereas the anode 730 and the first electrode 740 are at a voltage level of approximately +60 keV to +140 keV. Thereby, X-ray photons within the diagnostic relevant energy range may be generated.

The X-ray tube 700 further comprises a second electrode 770, which is mechanically and electrically coupled to the electron source 110 by means of a holder 771. Since the electron source 710 is arranged within the X-ray tube 700 in a spatial fixed position also the second electrode 770 is fixed within the X-ray tube 700.

When the first electrode 740 is located laterally beneath the electron source 710, the electron beam 720 is radially deflected towards the rotational axis 735 such that the electron beam 720 impinges onto the anode 730 within a first focal spot 721a. This situation is depicted in FIG. 1a. Thereby, the first electrode 740 acts like a pull electrode for all the electrons within the electron beam 720.

It has to be mentioned that due to the fact that the pull electrode 740 is located directly beneath the electron source 710 respectively the electron focusing device 715, the electrons of the electron beam 720 are accelerated predominately within the electric field extending in between the electron source 710 and the first electrode 740. In other words, the space between the first electrode 740 and the upper surface of the anode 730 comprises only a very weak electrical field. This means that in order not to allow for a strong defocusing of the electron beam 720 within this space the electron focusing device 715 has to be adjusted properly.

When the first electrode 740 is located at the opposite side of the electron source 710, the electrical field between the electron source 710 and the anode 730 is not or only very weakly influenced by the first electrode 740. Therefore, the electron beam 720 projects to the anode 730 in a predominately straight line such that the electron beam 720 impinges onto the anode 730 within a second focal spot 731b. This situation is depicted in FIG. 7b.

It should be clear that when the anode 730 rotates around the rotational axis 735 the focal spot 721a, 721b of the electron beam 720 switches between two spatially different positions. When the first electrode 740 is found laterally beneath the electron source 710, the electron beam 720 is deflected and the first focal spot 721a is located close to the base of the holder 745 (see FIG. 7a). When the first electrode 740 is not found in close proximity beneath the electron source 710, the electron beam 720 projects predominately in a straight line and the focal spot 721b is located at a predetermined distance from the base of the holder 745 (see FIG. 7b). Of course, the period of deflection is always shorter than the period on the anode revolution.

At this point it has to be mentioned that of course the presence of the first electrode 740 has an influence on the lines of electrical flux between the electron source 710 and the anode 730. In order to avoid a defocusing of the electron beam 720 and as a consequence an enlarged focal spot 721a, 721b, the electron focusing device 715 may be dynamically operated in synchronization with the anode movement such that both the deflected and the non-deflected electron beam 720 impinge on the anode surface with approximately the same degree of focusing.

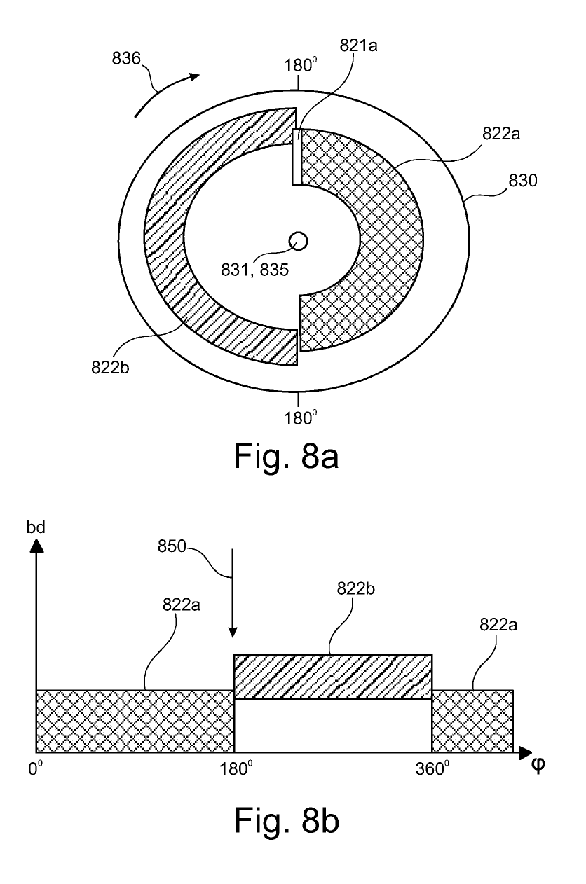

FIG. 8a shows a top view of the anode 730, which is now denoted with reference numeral 830. The anode 830, which is supported by the shaft 831, rotates clockwise as indicated by the arrow 836. The focal spot being generated on the anode surface is denoted with reference numeral 821a. The focal spot 821a has the shape of an elongated rectangle. However, since the X-rays being generated within the focal spot 821a are emitted in a radial direction outwards from the rotational axis 835, the projection of the focal spot 821a perpendicular to the direction emitted X-rays is much smaller. Preferably, in this projection the focal spot 821a has the shape of a square.

According to the embodiment described here, the pull electrode 740 covers one half of the anode 830. Therefore, within one revolution of the anode 830 two focal tracks are generated on the anode surface. A first focal track 822a is defined by the relative movement of the focal spot 821a on the anode surface, when the electron beam 720 is deflected as indicated in FIG. 7a. A second focal track 822b is defined by the relative movement of the focal spot 721b on the anode surface, when the electron beam 720 is not deflected as indicated in FIG. 7b.

FIG. 8b shows a diagram illustrating the temporal behavior of the beam deflection bd as a function of the phase φ of the rotation of the anode 830. The anode 830 typically rotates with a constant angular velocity such that the phase φ is directly proportional to the time t.

The beam deflection bd is depicted with a phasing of the anode movement relative to the focal spot position 821a, which phasing corresponds to the arbitrary phase points 0° and 180° as indicated in FIG. 8a. Thereby, in between a phase interval ranging from 0° to 180° the electron beam is deflected yielding the focal track 822a. In between the phase points 180° and 360° the electron beam is not deflected yielding the focal track 822b. The arrow 850 indicates the phasing of the anode movement, which phasing is depicted in FIG. 8a. Of course, due to the periodicity of the anode movement the beam deflection bd is also periodic with a period of 360°.

It has to be mentioned that of course also other segmentations of the electron deflection device 740 are possible. For instance the electron deflection device 740 may be formed in an asymmetric manner such that the temporal distribution between the deflected electron beam and the non-deflected electron beam is unequal. Further, the electron deflection device may also be formed with more than one segment in such a manner that during one revolution of the anode 740 the focal spot 721a, 721b is switched two times or even more often back and forth between two spatially different focal spots.

Further it is pointed out that the electron deflection device 740 may also be adapted such that during one revolution of the anode 730 three or even more spatially different focal spots are sequentially generated. In this case the electron deflection device has to comprise three or even more segments whereby each segment is assigned to a certain angular range of the rotatable anode 730.

It should be noted that the term “comprising” does not exclude other elements or steps and the “a” or “an” does not exclude a plurality. Also elements described in association with different embodiments may be combined. It should also be noted that reference signs in the claims should not be construed as limiting the scope of the claims.

In order to recapitulate the above described embodiments of the present invention one can state:

It is described an X-ray tube 100 comprising a rotating anode 130, which is provided with a pull electrode 140. The pull electrode 140 interacts with a fixed electron source 110 in order to generate a modulated electron beam 120a, 120b. The beam modulation may be an intensity variation and/or a spatial deflection. The pull electrode 140 is mounted in a fixed position with respect to the anode 130 and rotates together therewith. The pull electrode 140 may have a hole 141 for passing the electron beam 120a. When being in front of the electron source 110, the pull electrode 140 causes a high electric field 142a such that a strong electron beam 120a is generated. When being not in front of the electron source 110 only a low current or a zero current electron beam 120b is generated. However, the pull electrode 740 may also cause a radial beam deflection such that depending on the angular position of the anode 730 the position of a focal spot 721a, 721b of the electron beam 720 is varied.

### LIST OF REFERENCE SIGNS

100 X-ray tube

110 electron source

111 hot cathode

115 electron focusing device/wehnelt cylinder

120a electron beam (high current)

120b electron beam (low current)

121 focal spot

130 anode

135 rotational axis/z-axis

136 rotational direction

140 electromagnetic force generation device/pull electrode

141 opening/gap

142a electric pull field (strong)

142b electric pull field (weak)

145 holder

146 frame/spokes

222a first focal spot track (high electron beam current)

222b second focal spot track (low electron beam current)

230 anode

235 rotational axis/z-axis

236 rotational direction

240 electromagnetic force generation device/pull electrode

241 opening

246 frame/spokes

321 focal spot

322a focal spot track (high electron beam current)

322b focal spot track (low/zero electron beam current)

330 anode

335 rotational axis/z-axis

336 rotational direction

350 arrow indicating depicted time

bc beam current

φ phase of rotation

421 focal spot

422a focal spot track (high electron beam current)

422b focal spot track (low/zero electron beam current)

430 anode

435 rotational axis/z-axis

436 rotational direction

440 electromagnetic force generation device/pull electrode

446 frame/spokes

450 arrow indicating depicted time

bc beam current

φ phase of rotation

521 focal spot

530 anode

535 rotational axis/z-axis

536 rotational direction

540 electromagnetic force generation device/pull electrode

546 holder/spokes

560 electron-repelling device/electrically isolating material/electron mirror

600 X-ray tube

610 electron source

611 hot cathode

615 electron focusing device/wehnelt cylinder

620c blocked electron beam

630 anode

635 rotational axis/z-axis

636 rotational direction

640 electromagnetic force generation device/pull electrode

641 opening

642c electric repelling field

645 holder

646 frame/spokes

660 electron-repelling device/chargeable grid

661 voltage source

700 X-ray tube

710 electron source

711 hot cathode

715 electron focusing device/wehnelt cylinder

720 electron beam

721a first focal spot

721b second focal spot

730 anode

731 shaft

735 rotational axis/z-axis

736 rotational direction

740 electron deflection device/first electrode/pull electrode

745 holder

770 second electrode

771 holder for second electrode

821a first focal spot

822a first focal spot track (deflected electron beam)

822b second focal spot track (non-deflected electron beam)

830 anode

831 shaft

835 rotational axis/z-axis

836 rotational direction

850 arrow indicating depicted time

bd beam deflection

φ phase of rotation

1. An X-ray tube comprising
an electron source (110, 710), adapted for generating an electron beam (120a, 120b, 720) projecting along a beam axis,
an anode (130, 730), which is arranged within the beam axis such that the electron beam (120a, 120b, 720) impinges onto a focal spot (121, 721a, 721b) of a surface of the anode (130, 730), the anode (130, 730) being rotatable around a z-axis (135, 735), and
an electron beam manipulation device (140, 740), which is attached to the rotatable anode (130, 730).

2. The X-ray tube as set forth in claim 1, wherein
the electron beam manipulation device is an electromagnetic force generation device (140, 740), which is adapted to exert an electromagnetic force on electrons of the electron beam (120a, 120b, 720).

3. The X-ray tube as set forth in claim 2, wherein
the electromagnetic force generation device comprises an electrode (140, 740) for electrically manipulating the electron beam (120a, 120b, 720), wherein the electrode (140, 740) is connectable to a defined voltage level.

4. The X-ray tube as set forth in claim 3, wherein
the electrode (140, 740) is at the same voltage level as the anode (130, 730).

5. The X-ray tube as set forth in claim 3, wherein
the anode (130, 730) is a disk comprising a rotational symmetry with respect to the z-axis (135, 735) and wherein
in a top view of the anode (130, 730) the electrode (140, 740) covers at least one sector of the anode (130, 730).

6. The X-ray tube as set forth in claim 2, further comprising
an electron focusing device (115, 715), which is arranged in between the electron source (110, 710) and the electromagnetic force generation device (140, 740) when the angular position of the anode (130, 730) is within a predefined angular range.

7. The X-ray tube as set forth in claim 3, wherein
the electrode (140) comprises an opening (141).

8. The X-ray tube as set forth in claim 3, wherein
the electrode (140) comprises at least two parts, which are mechanically connected with each other by means of a holder (146).

9. The X-ray tube as set forth in claim 8, wherein
the holder (146) comprises a bar or a rod.

10. The X-ray tube as set forth in claim 8, wherein
the holder (146) is arranged within a region wherein due to the presence of the electrode (140) the electrical field between the electron source (110) and the anode (130) is reduced.

11. The X-ray tube as set forth in claim 3, wherein
the electromagnetic force generation device (140, 145) protrudes from the anode (130) in such a manner that, when the electromagnetic force generation device (140) is found in between the electron source (110) and the anode (130), only a small gap remains in between the electron source (110) and the electrode (140).

12. The X-ray tube as set forth in claim 3, wherein
the electromagnetic force generation device comprises at least two electrodes (440).

13. The X-ray tube as set forth in claim 3, further comprising
an electron-repelling device (560, 660), which is adapted to suppress the electron beam current at least partially when the electrode (540, 640) is in an angular position aside from the electron source (610).

14. The X-ray tube as set forth in claim 13, wherein
the electron-repelling device (660) is arranged in a spatially fixed position with respect to the electron source (610).

15. The X-ray tube as set forth in claim 14, wherein
the electron-repelling device is a grid (660), which is chargeable with a negative voltage with respect to the electron source (610).

16. The X-ray tube as set forth in claim 13, wherein
the electron-repelling device (560) is attached to the anode (530).

17. The X-ray tube as set forth in claim 16, wherein
the electron-repelling device (560) comprises an electrically isolating material.

18. The X-ray tube as set forth in claim 3, wherein
the electromagnetic force generation device is an electron deflection device (740) for spatially manipulating the electron beam (720).

19. The X-ray tube as set forth in claim 18, wherein
the electron deflection device (740) is adapted to radially deflect the electron beam (720) with respect to the z-axis (735).

20. The X-ray tube as set forth in claim 18, further comprising
a further electrode (770), wherein
the further electrode (770) is connectable to a further voltage level.

21. The X-ray tube as set forth in claim 20, wherein
the further electrode (770) is arranged is a spatially fixed position with respect to the electron source (710).

22. The X-ray tube as set forth in claim 20, wherein
the further electrode (770) is at the same voltage level as the electron source (710).

23. The X-ray tube as set forth in claim 18, wherein
the electron deflection device (740) protrudes from the anode (730) in such a manner that the electron beam (720) may be manipulated basically along the whole electron path length between the electron source (710) and the anode (730).

24. The X-ray tube as set forth in claim 18, wherein
the electron deflection device (740) is adapted to discretely deflect the electron beam (720) such that
a first focal spot (721a) is generated when the angular position of the anode (730) is within a first angular range and
a second focal spot (721b) is generated when the angular position of the anode (730) is within a second angular range.

25. An X-ray system, in particular a medical X-ray imaging system like a computed tomography system, the X-ray system comprising
an X-ray tube (100, 700) as set forth in claim 1.

26. A method for generating X-rays, in particular for generating X-rays being used for medical X-ray imaging like computed tomography, the method comprising
using an X-ray tube (100, 700) as set forth in claim 1.
